(19) United States
(12) Patent Application Publication
(10) Pub. No.: US 2013/0159915 A1
(43) Pub. Date: Jun. 20, 2013

(54) METHOD AND APPARATUS FOR CONTROLLING CONTENTS ON ELECTRONIC BOOK USING BEZEL

(71) Applicants: Sang Tae Kim, Daejeon (KR); Jae Jeung Kim, Daejeon (KR); Ho Won Lee, Daejeon (KR)

(72) Inventors: Sang Tae Kim, Daejeon (KR); Jae Jeung Kim, Daejeon (KR); Ho Won Lee, Daejeon (KR)

(21) Appl. No.: 13/744,571

(22) Filed: Jan. 18, 2013

(30) Foreign Application Priority Data
Feb. 29, 2012 (KR) 10-2012-0021318
Apr. 2, 2012 (KR) 10-2012-0033826

(51) Int. Cl. G06F 3/01

(52) U.S. Cl. CPC G06F 3/017
USPC 715/776

(57) ABSTRACT

An input area that is used for controlling contents is formed on the periphery of an electronic book by performing touch-dragging a bezel area by utilizing the bezel area that is arranged in a peripheral portion of a touch screen of the electronic book. Therefore, according to the present disclosure, even under an environment of a small screen, utilization of a space for operating contents can be effectively performed.

### CROSS-REFERENCE TO RELATED APPLICATION

This application claims priority of Korean Patent Application No. 10-2012-0021318, filed on Feb. 29, 2012 and priority of Korean Patent Application No. 10-2012-0033826, filed on Apr. 2, 2012, in the KIPO (Korean Intellectual Property Office), the disclosure of which is incorporated herein entirely by reference.

### BACKGROUND OF THE INVENTION

1. Field of the Invention

The present invention relates to a method and an apparatus for controlling contents of an electronic book using a bezel, and more particularly, to a method and an apparatus for controlling contents of an electronic book using a bezel that are capable of more effectively utilizing a touch screen space and controlling the contents by displaying an operating area used for controlling and operating an object displayed on the touch screen only using a dragging gesture from a bezel area located in a peripheral portion of the touch screen.

2. Description of the Related Art

As the kinds of electronic apparatuses diversify, various technologies are proposed which can decrease the sizes of the electronic apparatuses and increase the sizes of display screens thereof. As the sizes of electronic apparatuses decrease, the number of electronic apparatuses that recognize user's inputs through contact input devices increases, and, particularly, touch screen panels that implement input functions on display screens are applied to various apparatuses including mobile electronic devices.

The touch screen panels can be classified into a resistive type, a capacitive type, an ultrasonic type, and an infrared type, and the like based on the operating type. According to the capacitive type, a touch screen panel having a small thickness can be manufactured, and the touch screen panel has high durability and a multi-touch capability and is widely used in a variety of electronic apparatuses.

In a touch screen panel of the capacitive type, a transparent electrode patterned in a predetermined shape is attached to a transparent substrate, and the transparent electrode is electrically connected to a connection pad that is arranged on the transparent substrate. The connection pad is connected to a control module, and a change in capacitance that occurs in the transparent electrode in accordance with a contact is delivered to the control module, whereby a contact position and the like can be determined. However, by arranging a predetermined wiring on the transparent substrate so as to electrically connect the connection pad and the transparent electrode, a bezel area in which an image cannot be actually displayed due to the arrangement of the wiring increases, whereby the size of an effective display area may decrease. However, such a bezel area is also a constituent element that is located on one side of a user terminal provided with a touch screen, and accordingly, a technology for effectively utilizing the bezel area is necessary.

Terminals or user terminals can be classified into mobile (portable) terminals and stationary terminals based on the portability thereof. The mobile terminals can be further classified into handheld terminals and vehicle mount terminals based on user's direct portability. Such user terminals are implemented in the form of multimedia players that have multiple functions such as capturing a picture or a moving image, reproduction of a music file or a moving image file, gaming, and broadcasting reception in accordance with diversification of functions. In addition, terminals such as electronic books that can implement a function of connecting to a wireless internet and displaying a web page or a file viewer function of displaying the content of a text file are disclosed as well. In such electronic books, while it is important to display as many texts or pictures as possible within a narrow screen and display the texts and the pictures as larger as can be, there is a problem in that the bezel portion of the touch screen actually decreases an effective screen of an electronic book.

### SUMMARY OF THE INVENTION

Aspects of the present disclosure provide a method and an apparatus, which are conceptually new, for controlling an electronic book using a bezel area.

In accordance with one aspect of the present invention, A method of controlling contents of an electronic book that is provided with a touch screen on which objects that can be sequentially displayed are displayed, the method comprising; detecting a first dragging gesture that progresses from a touch made in a bezel area located on a periphery of the touch screen in a direction of the touch screen; and displaying an input area that can change order of the objects displayed on the touch screen in accordance with the first dragging gesture on the touch screen that is adjacent to the bezel area in which the first dragging gesture progresses.

Here, a position of the touch made in the bezel area is determined with reference to a position of the touch screen at which a touch is detected first in accordance with the first dragging gesture.

Alternatively, a position of the touch made in the bezel area is determined with reference to a position of the touch screen at which a touch is detected first in accordance with the first dragging gesture.

The method may further include sequentially changing over the objects displayed on the touch screen in accordance with a second dragging gesture in the input area, wherein a direction of the second dragging gesture is opposite to a direction of the first dragging gesture.

The first dragging gesture progresses from the right-side bezel to the left side. Further, the input area is formed on the right side and the second dragging gesture progresses from the input area to the right side.

Alternatively, the first dragging gesture progresses from the left-side bezel to the right side. Further, the input area is formed on the left side and the second dragging gesture progresses from the input area to the left side.

The input area is continuously displayed on the touch screen after the second dragging gesture ends. In addition, the objects are document files formed by a plurality of pages. Further, the size of the input area changes in accordance with a third dragging gesture that progresses in a boundary of the input area.

In accordance with another aspect of the present invention, there is provided an apparatus for controlling contents of an electronic book that is provided with a touch screen, the apparatus comprising: a touch detecting unit detecting a touch made on the touch screen; a memory unit storing a plurality of objects that can be sequentially displayed on the touch screen; a control unit displaying an input area that is capable of controlling the order of the displayed objects in a peripheral portion of the touch screen that is adjacent to a bezel area in accordance with a touch made on the bezel area located in the peripheral portion of the touch screen and a first dragging gesture that is continued from the touch on the touch screen; and a display unit differently displaying the order of the objects in accordance with a touch gesture made in the input area.

The control unit determines a position of the touch made in the bezel area with reference to a position of the touch screen at which a touch is detected first in accordance with a dragging gesture progressing from the bezel area.

Alternatively, the control unit determines a position of the touch made in the bezel area with reference to a direction of the dragging gesture on the touch screen.

The display unit sequentially changes over the objects displayed on the touch screen in accordance with a second dragging gesture, which is another dragging gesture, in the input area and a direction of the second dragging gesture is opposite to a direction of the first dragging gesture. In addition, the input area is continuously displayed on the touch screen after the second dragging gesture ends. Further, the objects are document files formed by a plurality of pages. Further, the size of the input area changes in accordance with a third dragging gesture that progresses in a boundary of the input area.

The first dragging gesture progresses from the right-side bezel to the left side and the second dragging gesture progresses from the input area to the right side.

Alternatively, the first dragging gesture progresses from the left-side bezel to the right side and the second dragging gesture progresses from the input area to the left side.

Additional aspects and/or advantages of the invention will be set forth in part in the description which follows and, in part, will be obvious from the description, or may be learned by practice of the invention.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a flowchart that illustrates a method of controlling contents of an electronic book according to an embodiment of the present disclosure.

FIGS. 2 to 5 are diagrams that illustrate a method of controlling a user terminal according to the present disclosure.

FIGS. 6a to 6c are diagrams that illustrate an electronic book control operation according to the present disclosure in an input area.

FIG. 7 is a block diagram of an apparatus for controlling contents of an electronic book according to an embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

In order to solve the above-described problems of related art, according to the present disclosure, a touch on a bezel area and a dragging connected therefrom to a touch screen are detected, and a content control area displayed on the touch screen is displayed in accordance with the detected touch-dragging gesture. Accordingly, an input area used for a content control operation does not need to be separately displayed on the touch screen, and the input area can be selectively generated in accordance with an intuitive dragging gesture from the bezel area.

Hereinafter, the present disclosure will be described in detail with reference to the drawings.

In order to solve the above-described technical problems, according to the present disclosure, a touch on the bezel area that is a non-touch area formed on the periphery of the touch screen and the position thereof are determined, and an electronic book is operated in accordance with an operation in the input area that is generated in accordance with the touch position described above. Hereinafter, the present disclosure will be described in detail based on embodiments.

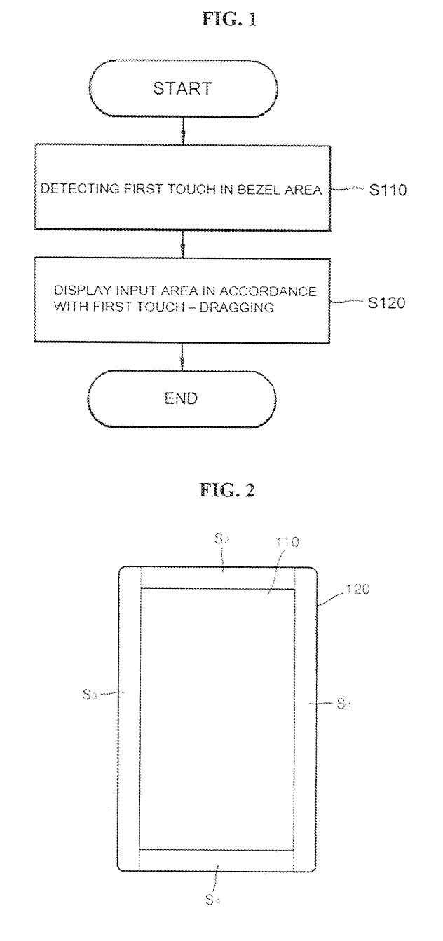

FIG. 1 is a flowchart that illustrates a method of controlling a user terminal according to an embodiment of the present disclosure.

As illustrated in FIG. 1, first, a touch on the bezel area that is located on the periphery of the touch screen is detected (S110). Here, since the bezel area is an area in which a touch cannot be actually detected in accordance with an electrical signal, in an embodiment of the present disclosure, the bezel area in which the touch has been detected in accordance with a touch signal (first touch) transmitted from a specific area (first area) of the touch screen that is adjacent to the bezel area is determined, and the touch position (first position) of the first touch may be a first or final touch that is detected on the touch screen. In other words, in a case where a dragging is made from the bezel area, the first touch may be the first touch made on the touch screen. On the other hand, in a case where the dragging is made from the touch screen to the bezel area, the first touch may be the final touch that is detected on the touch screen.

As above, according to the present disclosure, detection of a touch on the bezel area represents not detecting a touch according to an actual electrical signal but calculating and tracking a touch on the bezel area from the first or final touch made on the touch screen.

The input area in which the order of displayed objects can be changed is displayed on the touch screen in accordance with the touch on the bezel area and the dragging gesture to the touch screen that follows the touch, and, at this time, the input area is displayed on the touch screen that is adjacent to the bezel area in which the dragging gesture is made (S120).

According to the present disclosure, the dragging gesture that progresses from the bezel to the touch screen is a gesture for generating another input area that is distinguished from a gesture for turning pages of the electronic book in units of unit pages, whereby the degree of utilization of the space of the narrow touch screen is maximized.

FIGS. 2 to 5 are diagrams that illustrate a method of controlling a user terminal according to an embodiment of the present disclosure.

As illustrated in FIG. 2, first, the user terminal according to the present disclosure includes a touch screen 110, and a bezel area 120 of a predetermined size is formed on the periphery of the touch screen 110. In addition, the bezel area 120 is divided into unit areas S1, S2, S3, S4 that are used for determining an operating command.

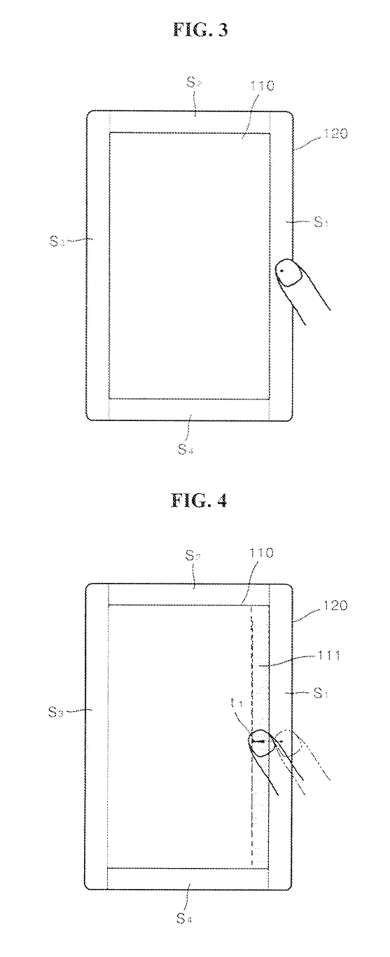

As illustrated in FIG. 3, first, a touch is made on the bezel area 120, and the touch on the bezel area 120 is not substantially detected. According to the present disclosure, the bezel area on which the touch is made is determined in accordance with a dragging that extends from the touch on the bezel area to the touch screen.

As illustrated in FIG. 4, the dragging that is consecutive to the touch on the bezel area progresses, and, at this time, the dragging direction is the direction of the touch screen. Accordingly, the touch is detected in an electrical manner on the touch screen.

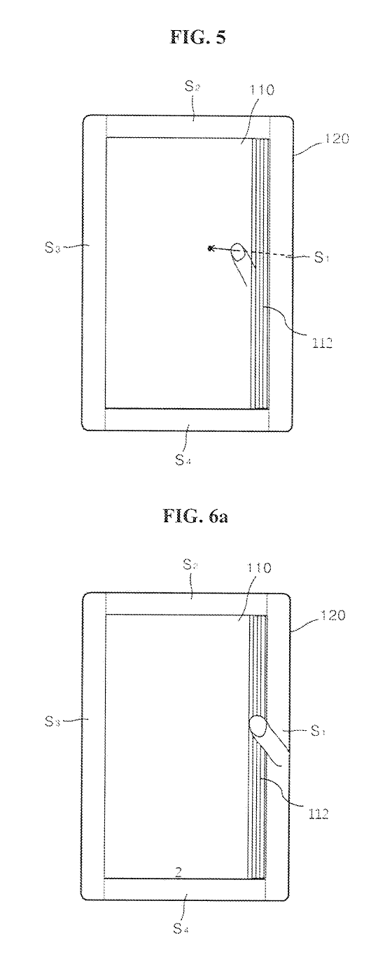

In FIG. 4, a first position t1 that is an outermost point of the touch screen 110 is a position at which the first touch occurs. Thus, according to the present disclosure, a bezel area S1 that is adjacent to the first position t1 is determined as a bezel area in which the touch occurs. In order to identify an operation command that is based on the bezel area and a command that is based on a direct input to the touch screen from each other, according to the present disclosure, a specific area 111 used for determining a bezel area is located in the outer portion of the touch screen, and a content control area (hereinafter, referred to as an input area 112) as illustrated in FIG. 5 is displayed on the touch screen that is adjacent to the bezel area in accordance with a touch on the outer area of the touch screen that is adjacent to the bezel area.

However, alternatively, a bezel area in which a touch is made may be determined based on a dragging direction vector according to a predetermined time interval on the touch screen.

FIG. 5 is a diagram that illustrates a manner in which the bezel area S1 is determined based on a vector extracted in the dragging direction, and the input area 112 used for controlling a content such as a page of the electronic book is displayed in the touch screen area adjacent to the bezel area.

Content that is displayed on the touch screen changes over in accordance with a touch event occurring in the input area that is displayed on the touch screen adjacent to the bezel area for which the touch has been determined.

For example, according to the present disclosure, an object that is displayed on the touch screen sequentially changes over in accordance with a second dragging gesture made in the input area. For example, in a case where an input area is formed on the right side of the touch screen, the input area is formed in accordance with a dragging gesture in the right-side bezel to the left side. That is, a first dragging gesture progresses from the right-side bezel to the left side. Accordingly, the input area is in a form in which all the pages of the electronic book are displayed at a predetermined gap, and a page turning event occurs in the dragging direction in the generated input area. When a second dragging gesture progresses from the generated input area to the right side, the page increases in a manner in which a page of the book is turned to the left side.

To the contrary, in a case where an input area is formed on the left side of the touch screen, the input area is formed in accordance with a dragging gesture in the left-side bezel to the right side. That is, a first dragging gesture progresses from the left-side bezel to the right side. Accordingly, the input area is in a form in which all the pages of the electronic book are displayed at a predetermined gap, and a page turning event occurs in the dragging direction in the generated input area. When a second dragging gesture progresses from the generated input area to the left side, the page decreases in a manner in which a page of the book is turned to the right side.

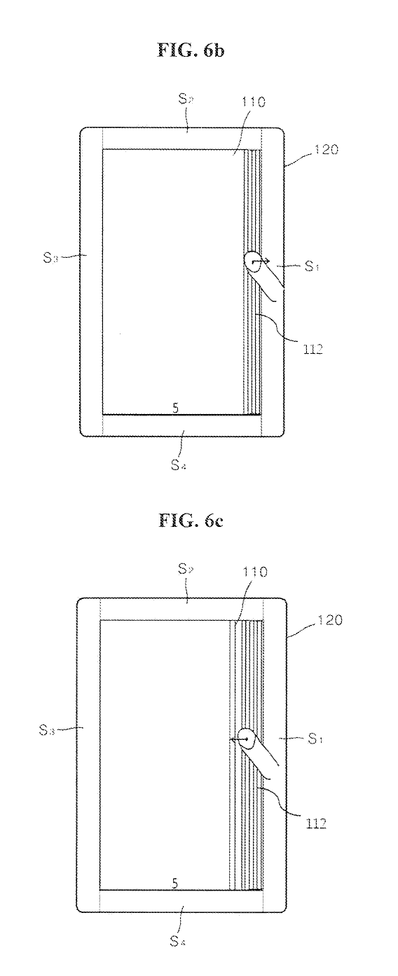

FIGS. 6a to 6c are diagrams that illustrate an electronic book control operation according to the present disclosure in an input area.

As illustrated in FIGS. 6a and 6b, first, an input area 112 that can generate an effect such as page turning according to a dragging that progresses from the bezel area to the touch screen is displayed as illustrated in FIGS. 2 to 5, and, here, the position at which the input area is generated corresponds to the bezel area in which a touch is detected.

According to another embodiment of the present disclosure, the input area 112 that is generated by the dragging gesture made in the bezel area that is continued to the touch screen can be continuously displayed on the touch screen even after the dragging gesture ends. Accordingly, a user can freely perform a search for a content displayed in accordance with a touch-dragging in the input area and a changeover of the content.

According to further another embodiment of the present disclosure, the size of the input area changes in accordance with a touch-dragging made from the boundary of the input area (see FIG. 6c).

For example, in a case where a page is searched for with high accuracy, it is preferable that the input area is wide. To the contrary, in a case where a fast search is necessary, it is preferable that the input area is narrow. For this, according to the present disclosure, a technical configuration is provided in which, even after the input area is formed in accordance with the dragging made in the bezel, the size of the input area changes in accordance with a dragging that progresses from another touch after the boundary of the input area is touched again.

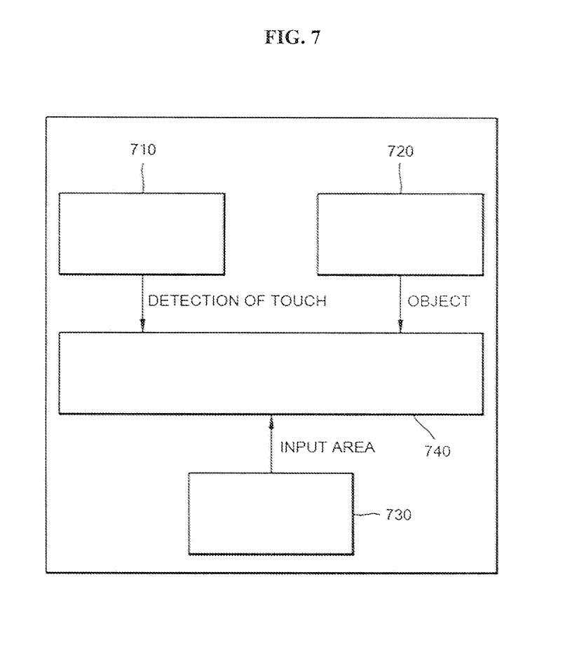

FIG. 7 is a block diagram of an apparatus for controlling contents of an electronic book according to an embodiment of the present disclosure.

As illustrated in FIG. 7, the apparatus for controlling the contents of an electronic book according to the present disclosure includes: a touch detecting unit 710 used for detecting a touch on the touch screen; a memory unit 720 storing a plurality of objects that can be sequentially displayed on the touch screen; a control unit 730 displaying an input area that can control the order of the displayed objects in the peripheral portion of the touch screen that is adjacent to the bezel area in accordance with a touch on the bezel area located on the periphery of the touch screen and a first dragging gesture being connected from the touch on the touch screen; and a display unit 740 differently displaying the order of the objects in accordance with a touch gesture made in the input area.

The control unit 730 of the apparatus for controlling the contents of an electronic book according to the present disclosure determines a touch position in the bezel area with reference to a position on the touch screen at which a touch is detected first in accordance with a dragging gesture that progresses from the bezel area included in the peripheral portion of the touch screen, which is the same as described with reference to FIGS. 2 to 5.

Alternatively, the control unit according to the present disclosure may determine a touch position in the bezel area with reference to the direction of the dragging gesture on the touch screen, which is the same as described above.

Thereafter, the display unit sequentially changes over the object displayed on the touch screen in accordance with a second dragging gesture that progresses in the input area, and, for example, the direction of the second dragging gesture may be opposite to the direction of the first dragging gesture.

In addition, the present disclosure provides an electronic book that includes the above-described apparatus for controlling the contents of the electronic book. Here, the electronic book includes any form of the electronic apparatus that includes a touch screen.

Furthermore, the method and the apparatus for controlling the contents of an electronic book according to the present disclosure can be implemented as computer-readable codes on a recoding medium that can be read by a computer. The recording medium that can be read by a computer includes any kind of recoding apparatus in which data that can be read by a computer system is stored. Examples of the recording medium include a ROM, a RAM, an optical disc, a magnetic tape, a floppy disk, a hard disk, and a non-volatile memory, and the recording medium may be implemented in the form of a carrier wave (for example, transmission through the Internet). In addition, the recording medium that can be read by a computer may be distributed to computer systems that are connected to each other through a network, and a computer-readable code may be stored and executed in a distributed manner.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method of controlling contents of an electronic book that is provided with a touch screen on which objects that can be sequentially displayed are displayed, the method comprising:
detecting a first dragging gesture that progresses from a touch made in a bezel area located on a periphery of the touch screen in a direction of the touch screen; and
displaying an input area that can change order of the objects displayed on the touch screen in accordance with the first dragging gesture on the touch screen that is adjacent to the bezel area in which the first dragging gesture progresses.

2. The method of controlling contents of an electronic book of claim 1, wherein a position of the touch made in the bezel area is determined with reference to a position of the touch screen at which a touch is detected first in accordance with the first dragging gesture.

3. The method of controlling contents of an electronic book of claim 1, wherein a position of the touch made in the bezel area is determined with reference to a direction of the first dragging gesture.

4. The method of controlling contents of an electronic book of claim 1, further comprising:
sequentially changing over the objects displayed on the touch screen in accordance with a second dragging gesture in the input area, wherein a direction of the second dragging gesture is opposite to a direction of the first dragging gesture.

5. The method of controlling contents of an electronic book of claim 4, wherein the first dragging gesture progresses from the right-side bezel to the left side.

6. The method of controlling contents of an electronic book of claim 5, wherein the input area is formed on the right side and the second dragging gesture progresses from the input area to the right side.

7. The method of controlling contents of an electronic book of claim 4, wherein the first dragging gesture progresses from the left-side bezel to the right side.

8. The method of controlling contents of an electronic book of claim 7, wherein the input area is formed on the left side and the second dragging gesture progresses from the input area to the left side.

9. The method of controlling contents of an electronic book of claim 4, wherein the input area is continuously displayed on the touch screen after the second dragging gesture ends.

10. The method of controlling contents of an electronic book according of claim 9, wherein the objects are document files formed by a plurality of pages.

11. The method of controlling contents of an electronic book of claim 10, wherein the size of the input area changes in accordance with a third dragging gesture that progresses in a boundary of the input area.

12. An apparatus for controlling contents of an electronic book that is provided with a touch screen, the apparatus comprising:
a touch detecting unit detecting a touch made on the touch screen;
a memory unit storing a plurality of objects that can be sequentially displayed on the touch screen;
a control unit displaying an input area that is capable of controlling the order of the displayed objects in a peripheral portion of the touch screen that is adjacent to a bezel area in accordance with a touch made on the bezel area located in the peripheral portion of the touch screen and a first dragging gesture that is continued from the touch on the touch screen; and
a display unit differently displaying the order of the objects in accordance with a touch gesture made in the input area.

13. The apparatus for controlling contents of an electronic book of claim 12, wherein the control unit determines a position of the touch made in the bezel area with reference to a position of the touch screen at which a touch is detected first in accordance with a dragging gesture progressing from the bezel area.

14. The apparatus for controlling contents of an electronic book of claim 12, wherein the control unit determines a position of the touch made in the bezel area with reference to a direction of the dragging gesture on the touch screen.

15. The apparatus for controlling contents of an electronic book of claim 12, wherein the display unit sequentially changes over the objects displayed on the touch screen in accordance with a second dragging gesture, which is another dragging gesture, in the input area and a direction of the second dragging gesture is opposite to a direction of the first dragging gesture.

16. The apparatus for controlling contents of an electronic book of claim 15, wherein the input area is continuously displayed on the touch screen after the second dragging gesture ends.

17. The apparatus for controlling contents of an electronic book of claim 16, wherein the objects are document files formed by a plurality of pages.

18. The apparatus for controlling contents of an electronic book of claim 17, wherein the size of the input area changes in accordance with a third dragging gesture that progresses in a boundary of the input area.

19. The apparatus for controlling contents of an electronic book of claim 15, wherein the first dragging gesture progresses from the right-side bezel to the left side and the second dragging gesture progresses from the input area to the right side.

20. The apparatus for controlling contents of an electronic book of claim 15, wherein the first dragging gesture progresses from the left-side bezel to the right side and the second dragging gesture progresses from the input area to the left side.
